(19) United States
(12) Patent Application Publication
(10) Pub. No.: US 2024/0269997 A1
(43) Pub. Date: Aug. 15, 2024

(54) A PLOTTER FOR DIGITAL PRINTING OF A DEFORMABLE OR YIELDING MATERIAL

(71) Applicant: SYSTEM CERAMICS S.P.A., FIORANO MODENESE(MO) (IT)

(72) Inventor: MARCO VALENTINI, CASALGRANDE (REGGIO EMILIA) (IT)

(21) Appl. No.: 18/569,748

(22) PCT Filed: Jul. 26, 2022
(86) PCT No.: PCT/IB2022/056878

§ 371 Date: Dec. 13, 2023

(30) Foreign Application Priority Data
Jul. 27, 2021 (IT) 102021000019958

(51) Int. Cl. B41J 11/14; B41J 11/06; B41J 11/20

(52) U.S. Cl. CPC B41J 11/14; B41J 11/06; B41J 11/20

(57) ABSTRACT

Plotter for digital printing, including
a main structure, arranged to be rested on a support surface;
a printing head, associated with the main structure and movable along a substantially horizontal transverse direction, for a predetermined stroke in alternating and opposite directions;
a transport device, arranged to lead a material to be printed forwards along a longitudinal direction which is substantially horizontal and perpendicular to the transverse direction.

The transport device is removably associated with the main structure by means of connection means. The connection means is arranged to assume an operating configuration, in which the transport device is connected to the main structure in a substantially rigid manner with respect to direct movements along the longitudinal direction and with respect to direct movements along the transverse direction, and a non-operating configuration, in which the transport device is movable with respect to the main structure.

The present invention relates to a plotter for digital printing. In particular, the invention relates to a plotter for the digital printing of a deformable or yielding material, such as fabric, paper, plastic films or the like.

For several years, digital plotter-type printers have been widely used for the printed decoration of such materials.

In summary, such printers comprise a transport device, arranged to carry the material to be decorated forwards along an advancement direction. In the plotters for fabrics, the transport device comprises a belt having an upper active portion, lying on a horizontal plane, intended to receive and support the fabric to be decorated. The belt is driven in sliding by a motorisation system, so that the active portion advances step by step along the advancement direction.

The printed decoration is performed by a decorating head, placed above the transport device, which is movable by alternating strokes in opposite directions along a horizontal direction perpendicular to the advancement direction. The decoration of the material to be printed substantially occurs in consecutive strips: in practice, the material to be printed advances step by step and, at each stop, the decorating head performs a stroke, applying a portion of the envisaged decoration.

In order for the fabric, or the deformable or yielding material in general, to be kept in a well-stretched and flat configuration, and not assume undulations or folds during the step-by-step advancement motion, the belt is sprinkled with a layer of sticky resin, which maintains the fabric or other material well adherent to the active portion.

The good adhesiveness of the resin layer is essential so that the decoration can be applied with precision. However, the adhesiveness of the resin layer is reduced over time by the progressive accumulation of particles and filaments which detach from the processed material, in particular in the case of a fabric. It is thus necessary to periodically subject the belt to maintenance operations aimed at restoring the adhesiveness of the resin layer.

During such operations, the belt must be stopped and subjected to various activities of cleaning, removal of the old resin layer, application of a new resin layer, and waiting for the new resin layer to complete polymerisation. In the currently available plotters, the transport device is integral with the overall structure of the machine. During the belt maintenance operations, which are relatively long and quite frequent, the plotter is in a stopped condition, i.e., in non-productive conditions. This obviously translates into a considerable reduction in productivity, especially in plants arranged for large-scale production. To limit the losses due to the stoppage of a plotter, it is often necessary to arrange a greater number of plotters in the plant, so as to compensate for the overall decrease in productivity during the stoppage periods.

An example of the type of plotter summarised above is described in the document EP0666180. Such a document describes a plotter for fabrics, provided with a conveyor belt for the fabrics to be printed. The document addresses, among other issues, the problem of facilitating the maintenance/replacement of the conveyor belt. To this end, the described plotter shows the possibility of moving only the conveyor belt in an easy-to-access position. The replacement of the belt is certainly facilitated in such a position, but the belt must still be disassembled from the motorisation system. In other words, the belt movement mechanism does not allow a rapid replacement of the entire conveyor belt, including the motorisation system.

The object of the present invention is to offer a plotter for digital printing of a deformable or yielding material, for example a fabric, paper, plastic films or the like, which allows to overcome the disadvantages summarised above. The main advantage of the plotter according to the present invention is that it allows to drastically reduce the stoppage times for maintenance operations on the transport device and/or on the conveyor belt.

Additional features and advantages of the present invention will become more apparent from the detailed description that follows of an embodiment of the invention in question, illustrated by way of non-limiting example in the appended figures, in which:

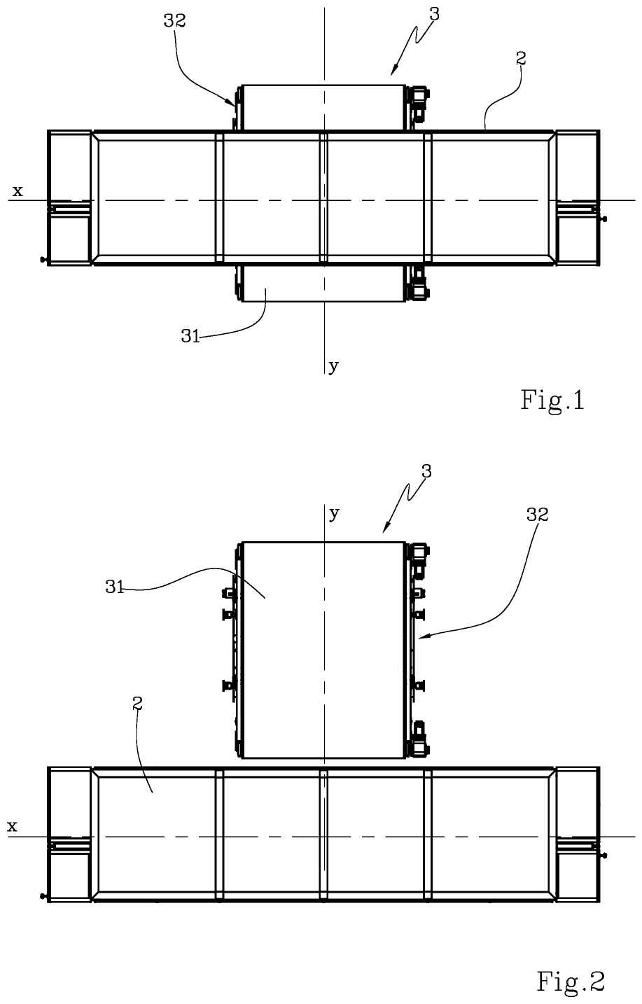

FIGS. 1 and 2 respectively show a top view of the plotter according to the present invention, respectively in an operating configuration and in a non-operating or maintenance configuration;

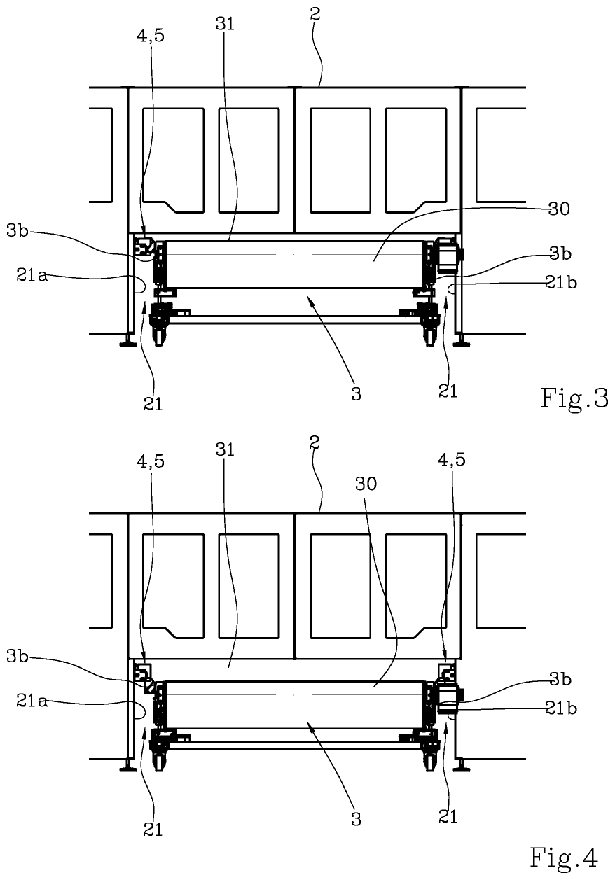

FIGS. 3 and 4 respectively show a front view of the plotter, respectively in the operating configuration and in the non-operating or maintenance configuration;

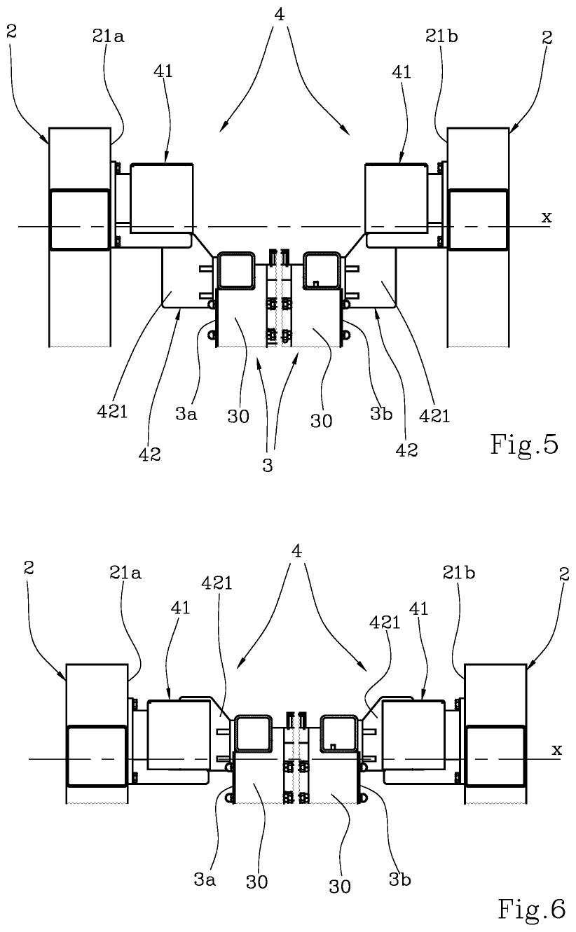

FIGS. 5,6,7 show various views of a longitudinal constraint (4); a transport device (3,30) is depicted interrupted, to approach two lateral zones;

FIG. 8 shows a detail of the longitudinal constraint (4);

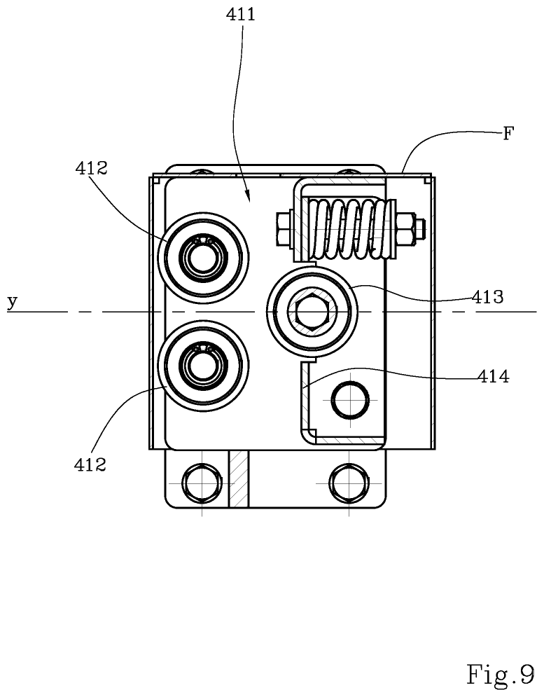

FIG. 9 shows a sectional view of the detail of FIG. 8;

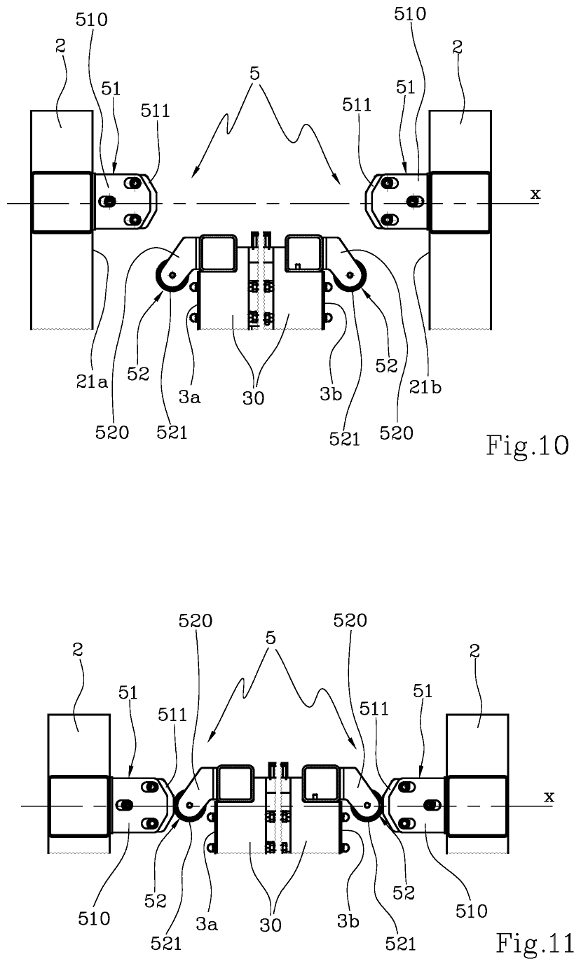

FIGS. 10 to 13 show various views of a transverse constraint (5).

The plotter for digital printing according to the present invention is particularly suitable for printing deformable or yielding materials. By deformable or yielding materials it is intended to indicate materials which tend to maintain the shape in which they are arranged, or that, if they are arranged resting on a surface in a bent or corrugated configuration, they are not capable of independently assuming a flat configuration. Examples of deformable or yielding materials are fabrics, paper, plastic film or the like. In the following description, the deformable or yielding material intended to receive the print is indicated simply as material, material to be printed or material to be processed.

The plotter for digital printing according to the present invention comprises a main structure (2), arranged to be rested on a support surface (E). The support surface (E), for example, the ground or a floor placed at any height. The main structure (2) substantially comprises a support frame, not illustrated in detail as known in the field in various shapes and sizes, for the support of various known mechanical and electronic parts of the plotter.

The plotter further comprises a printing head, associated with the main structure (2) and movable along a substantially horizontal transverse direction (X), for a predetermined stroke in alternating and opposite directions. The printing head is not depicted in the figures, as it is a device well known in the art. Preferably, the printing head is digital, i.e., it comprises a plurality of ink-jet printing heads. The printing heads, of the known type, each comprise a plurality of emission nozzles of a printing liquid, ink or other, and are distributed so as to form a substantially continuous printing front, applicable to the material to be printed. In a known manner in the field, the heads are distributed so that the emission nozzles are substantially on a horizontal emission plane and, overall, are capable of emitting a flow of printing liquid which uniformly covers a flat surface whose dimensions depend on the arrangement of the heads, their number and the length of the stroke followed by the printing head.

Guiding means, known in the field, is associated with the main structure (2) to allow the movement of the printing head along the transverse direction (X) by motor means, also known in the field. A control module is arranged to control the movement of the printing head, the movement of the object to be printed and to coordinate the individual nozzles of the printing heads so as to produce the desired image.

The main structure (2) comprises a compartment (21), i.e., a housing facing downwards and open on the bottom. In other words, the compartment (21) substantially defines a tunnel, open downwards. The compartment (21) is positioned below the printing head, i.e., below the round-trip path followed by the printing head.

The compartment (21) has two opposite sides (21a,21b), substantially parallel to the longitudinal direction (Y). In the depicted embodiment, the two sides of the compartment (21) substantially lie on a vertical plane parallel to the longitudinal direction (Y).

The plotter comprises a transport device (3), arranged to lead the material to be printed forwards along a longitudinal direction (Y) which is substantially horizontal and perpendicular to the transverse direction (X). The transport device (3) is provided with its own load-bearing frame (32), i.e., separated from the main structure (2). The load-bearing frame (32) is structured to allow the support of the various parts and components forming the transport device as a whole. Preferably, the load-bearing frame (32) is configured to allow resting the transport device (3) on the ground. Connection means (4,5) is arranged to allow the coupling and the release of the transport device (3), i.e., the load-bearing frame (32) of the transport device (3), from the main structure (2).

Preferably, the transport device (3) comprises a conveyor belt having an upper active portion (31), lying on a horizontal plane, intended to receive and support the material to be printed. The belt is driven in sliding by a motorisation system, well known in the field, so that the active portion advances step by step along the advancement direction. Both the conveyor belt with the relative upper active portion (31), and the relative motorisation system, are supported by the load-bearing frame (32). As already noted, the control module is arranged to control the movement of the printing head, the movement or advancement of the object to be printed, by advancing the upper active portion (31), and to coordinate the individual nozzles of the printing heads in order to produce the desired image. In a known manner, the printed decoration is performed by the printing head, placed above the transport device, which is movable by alternating strokes in opposite directions along a horizontal direction perpendicular to the advancement direction. The decoration of the material substantially occurs in consecutive strips: in practice, the material advances step by step through the upper active portion (31) of the conveyor belt and, at each stop, the decorating head performs a stroke, applying a portion of the envisaged decoration.

Preferably, the conveyor belt is sprinkled with a layer of sticky resin, which keeps the material to be printed well adherent to the upper active portion 30 (31). The transport device (3) is arranged in the compartment (21), with the longitudinal direction (Y) oriented perpendicular to the transverse direction (X). The transport device (3) has two opposite sides (3a,3b), which lie overall on vertical planes parallel to the longitudinal direction (Y). In particular, said sides (3,a, 3b) are opposite portions of the load-bearing frame (32) of the transport device (3). Each side (3a,3b) of the transport device faces a respective side (21a, 21b) of the compartment (21).

In the plotters currently available on the market, the transport device (3) is integral with the main structure (2).

Conversely, advantageously, in the plotter according to the present invention the transport device (3) is removably associated with the main structure (2) by connection means (4,5). In other words, the transport device (3) is associated in a dismountable manner with respect to the main structure (2).

In particular, as already underlined, the transport device (3) is provided with a load-bearing frame (32), i.e., separated from the main structure (2). Connection means (4,5) is arranged to allow the coupling and the release of the transport device (3), i.e., the load-bearing frame (32) of the transport device (3), from the main structure (2).

This makes it possible to remove a transport device (3), in order to perform every planned or necessary maintenance operations, and to position another transport device (3) in the plotter, already in ready-to-use conditions. The replacement of a transport device (3) to be restored with a transport device (3) already ready for use is a relatively fast operation, and in any case much faster than any maintenance operation to be performed on the transport device (3).

For example, any necessary and periodic maintenance operation aimed at restoring the adhesiveness of the resin layer applied to the conveyor belt, during which the belt must be stopped and subjected to various activities of cleaning, removal of the old resin layer, application of a new resin layer, and waiting for the new resin layer to complete polymerisation, can be performed without the need to stop the plotter for all the necessary time. The plotter can be stopped only for the time necessary to replace the transport device (3), a very short time, after which it can be put back into operation.

The connection means (4,5) is arranged to assume an operating configuration, in which the transport device (3) is connected to the main structure (2) in a substantially rigid manner with respect to direct movements along the longitudinal direction (Y) and with respect to direct movements along the transverse direction (X), and a non-operating configuration, in which the transport device (3) is movable with respect to the main structure (2). In particular, in the non-operating configuration of the connection means (4,5) the load-bearing frame (32) of the transport device (3) is separated or released from the main structure (2). This allows to remove the transport device (3) from the main structure (2), and to position another transport device (3) in place of the removed one.

With the indication that the transport device (3) is connected to the main structure (2) in a substantially rigid manner in the operating configuration of the connection means (4,5), it is intended that the transport device (3) cannot move with respect to the main structure (2) in normal operating conditions of the plotter, i.e., during the course of a printing production cycle. In the operating configuration of the connection means (4,5), the plotter is in normal operating conditions, for the application of the envisaged printed decorations on a material to be printed carried forwards by the transport device (3). In the non-operating configuration of the connection means (4,5), the plotter is in a stopped condition, to allow the removal of the transport device (3) and its replacement with another transport device (3).

In the depicted, preferred but not exclusive embodiment, the connection means (4,5) comprises a longitudinal constraint (4), visible in greater detail in FIGS. 5 to 9. The longitudinal constraint (4) is arranged to assume a locking configuration, in which it prevents the movements of the transport device (3) with respect to the main structure (2) along the longitudinal direction (Y), and an unlocking configuration, in which it does not prevent the movements of the transport device (3) with respect to the main structure (2) along the longitudinal direction (Y).

Also in this case, with the indication that the longitudinal constraint (4) prevents the movements of the transport device (3) with respect to the main structure (2) along the longitudinal direction (Y), it is intended that the longitudinal constraint (4), in the locking configuration, prevents the transport device from moving with respect to the transport device (3) along the longitudinal direction (Y).

In a preferred but not exclusive manner, the longitudinal constraint (4) comprises at least one housing assembly (41), integral with one of the main structure (2) or the transport device, and an engagement assembly (42), integral with the other of the main structure (2) or the transport device (3). The engagement assembly (42) is insertable in the housing assembly (41) in the locking configuration of the longitudinal constraint (4).

In the depicted embodiment, the housing assembly (41) is integral with the main structure (2), while the engagement assembly (42) is integral with the transport device (3). In an alternative embodiment, not shown, the housing assembly (41) is integral with the transport device (3), while the engagement assembly (42) is integral with the main structure (2).

Preferably, but not necessarily, the engagement assembly (42) is insertable in the housing assembly (41) by means of a movement comprising a vertical component. Such a movement will be described in more detail below.

Preferably, the housing assembly (41) comprises at least two slots (411) arranged on opposite sides of the compartment (21) intended to accommodate the transport device (3). More preferably, the housing assembly (41) comprises four slots (411), arranged two by two on the opposite sides (21a,21b) of the compartment (21). Each slot (411) is oriented on a substantially vertical plane, perpendicular to the longitudinal direction (Y), i.e., it is accessible along at least one vertical direction.

Preferably, the engagement assembly (42) comprises at least two plates (421), arranged on the opposite sides (3a,3b) of the transport device (3), in a position such as to be able to be inserted in a respective slot (411), in the locking configuration. More preferably, the engagement assembly (42) comprises four plates (421), arranged two by two on opposite sides (21a,21b) of the transport device (3), in a position such as to be able to be inserted in a respective slot (411). Each plate (421) lies on a substantially vertical plane, perpendicular to the longitudinal direction (Y), such as to be able to be inserted in the respective slot (411) with a movement which has at least one vertical component.

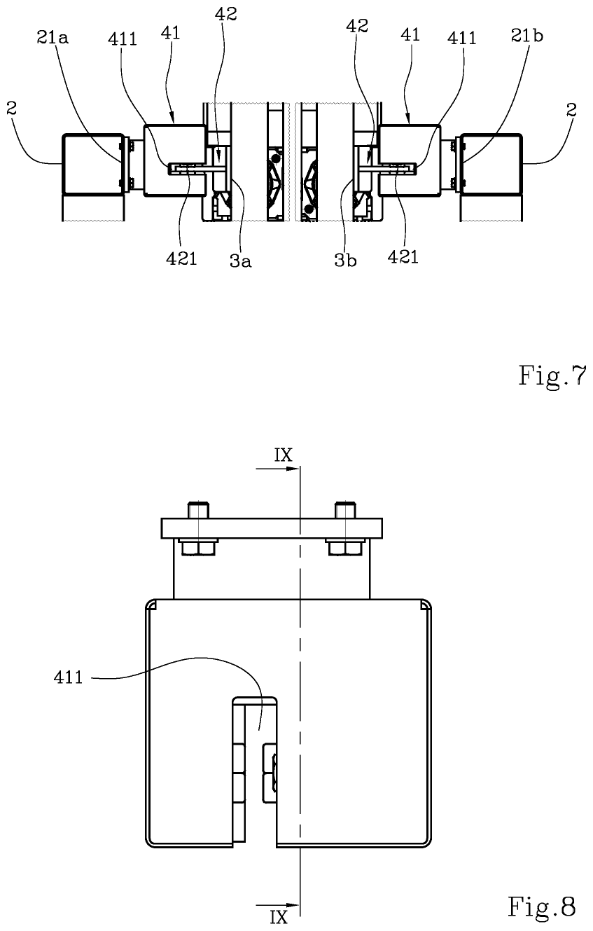

In the locking configuration of the longitudinal constraint (4), visible in FIGS. 6 and 7, each plate (421) is inserted in a respective slot (411). In such a configuration, i.e., when each plate (421) is inserted in a respective slot (411), no direct movement along the longitudinal direction (Y) is possible therebetween.

As shown in FIG. 9, preferably each slot (411) is at least partially laterally delimited by wheels (412,413) mounted idle on horizontal rotation axes perpendicular to the longitudinal direction (Y). A pair of first wheels (412) is arranged on a first side of the slot (411). At least a second wheel (413) is arranged on the opposite side of the slot (411). In the locking configuration, a plate (421) is arranged in the space delimited, on one side, by the first wheels (412), on the other side by the second wheel (413). The second wheel (413) is preferably mounted on an elastic support (414), elastically sliding in a direction parallel to the longitudinal direction (Y). The elastic support (414) pushes the second wheel (413) towards the pair of first wheels (412), so that the second wheel (413) is placed elastically in contact with the plate (421).

In the depicted embodiment, the elastic support (414) comprises an attachment part (414), to which the second wheel (413) is associated. The attachment part (414) is slidably associated with a part (F) integral with the main structure (2). An elastic means is interposed between such a part (F) and the attachment part (414), for example a helical spring. The elastic means used has elastic features such as to favour the engagement of the longitudinal constraint (4), but such as to substantially prevent any movement of the transport device (3) with respect to the main structure (2) along the longitudinal direction (Y). In particular, the elastic means is structured or configured so as not to substantially deform under the effect of the inertial thrust due to the intermittent advancement of the conveyor belt of the transport device (3).

The connection means (4,5) further comprises a transverse constraint (5), visible in greater detail in FIGS. 10 to 13. The transverse constraint (5) is arranged to assume a locking configuration, in which it prevents the movements of the transport device (3) with respect to the main structure (2) along the transverse direction (X), and an unlocking configuration, in which it does not prevent the movements of the transport device (3) with respect to the main structure (2) along the transverse direction (X).

As already underlined for the longitudinal constraint (4), with the indication that the transverse constraint (5) prevents the movements of the transport device (3) with respect to the main structure (2) along the transverse direction (X), it is intended that the transverse constraint (5), in the locking configuration, prevents the transport device from moving with respect to the transport device (3) along the transverse direction (X).

In a preferred but not exclusive manner, the transverse constraint (5) comprises at least a first abutment (51), integral with one of the main structure (2) or the transport device (3), and at least a second abutment (52), integral with the other of the main structure (2) or the transport device (3).

In the locking configuration of the transverse constraint (5), visible in FIG. 11, the first abutment (51) and the second abutment (52) are in contact with each other and are substantially locked with respect to the direct movements along the transverse direction (X).

In a preferred, non-exclusive embodiment, the first abutment (51) comprises a rest surface (511), facing the second abutment (52). The rest surface (511) is overall perpendicular to a vertical plane, perpendicular to the longitudinal direction (Y). Preferably, the rest surface (511) has at least one active portion lying on a vertical plane, parallel to the longitudinal direction (Y).

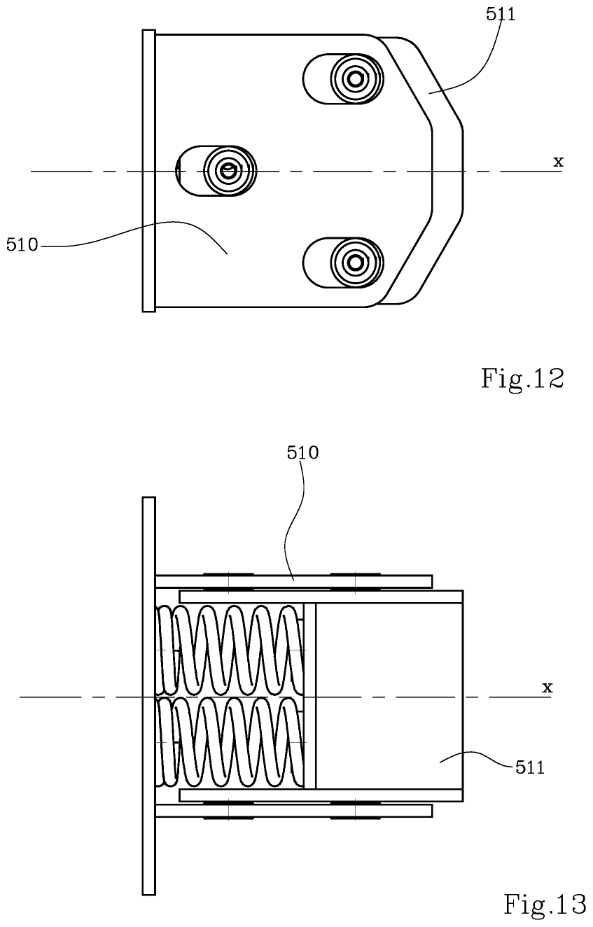

In the embodiment depicted, the first abutment (51) is associated with the load-bearing structure (2), and in particular with the compartment (21). The first abutment (51) comprises at least two blocks (510), each of which is provided with a rest surface (511). The two blocks (510) are located on opposite sides of the compartment (21), with the respective rest surfaces (511) facing each other, or facing the central area of the compartment (21). In an alternative embodiment, not illustrated, the blocks (510) could be associated with opposite sides of the transport device (3). In such a case, the rest surfaces (511) are associated with the opposite sides of the transport device, each facing a respective side of the compartment (21). In the embodiment depicted in FIGS. 12 and 13, the rest surface (511) is associated with the respective block (510) with the possibility of elastically sliding in a direction parallel to the transverse direction (X), by a stroke of limited extent. An elastic means, for example one or more helical springs, is interposed between the rest surface (511) and the block (510).

The elastic means used has elastic features such as to favour the engagement of the transverse constraint (5), but such as to substantially prevent any movement of the transport device (3) with respect to the main structure (2) along the transverse direction (X). In particular, the elastic means is structured or configured so as not to substantially deform under the effect of the inertial thrust due to the alternating strokes of the printing head along the transverse direction (X).

More preferably, the first abutment (51) comprises four blocks (510), associated with the main structure (2), arranged two by two on opposite sides of the compartment (21).

In a preferred, non-exclusive embodiment, the second abutment (52) in turn comprises a rest surface (521), intended to be positioned in contact with the rest surface (511) of the first abutment (51).

In the embodiment depicted, the second abutment (52) is associated with the transport device (3). The second abutment (52) in turn comprises two blocks (520), each of which is provided with a rest surface (521). The two blocks (520) are located on opposite sides of the transport device (3), with the rest surfaces (521) facing a respective rest surface (511) of the first abutment (51). In an embodiment not depicted, in which the first abutment (51) is associated with the transport device (3), the blocks (520) of the second abutment (52) would be associated with opposite sides of the compartment (21).

Preferably, but not necessarily, each rest surface (521) of the second abutment (52) is cylindrical in shape, concentric to an axis parallel to the longitudinal direction (Y). More preferably, the rest surface (521) is defined by a roller, i.e., it is located on the surface of a roller (523), rotating around an axis parallel to the longitudinal direction (X). This promotes the sliding of the rest surface (521) of the second abutment (52) on the rest surface (511) of the first abutment (51).

More preferably, the second abutment comprises four blocks (520), associated two by two on opposite sides of the transport device (3). In the locking configuration, each block (510) of the first abutment (51) is aligned and facing a respective block (520) of the second abutment (52), with the respective rest surfaces (511,521) arranged in contact.

As already mentioned, the first abutment (51) and the second abutment (52) are arranged in contact with each other, in the locking configuration of the transverse constraint (5), by means of a movement which comprises a vertical component, as occurs for each plate (421) and each slot (411) of the longitudinal constraint (4).

Preferably, such vertical movement is obtained by a vertical movement of at least one portion of the transport device (3), to which the engagement assembly (42) and the second abutment (52) are associated. To this end, at least one portion of the transport device (3) is vertically movable with respect to the main structure (2). In particular, the vertical movement between the locking and unlocking configurations is obtained by vertically translating an upper portion (30) of the transport device (3) with respect to a lower rest portion of the transport device (3). Each second abutment (52) and the engagement assembly (42) are associated with the upper portion of the transport device (3).

In particular, the transport device (3) can assume an operating position, in which the upper portion (30) is at a greater height, and a non-operating position, in which the upper portion (30) is at a lesser height.

In the non-operating position of the transport device (3), the connection means (4,5) is in non-operating configuration, i.e., the longitudinal constraint (4) and the transverse constraint (5) are in release configuration. The transport device (3) can thus be moved with respect to the main structure (2), for example it can be moved away from the compartment (21) to be replaced with another transport device (3).

After placing the transport device inside the compartment (21), in a predetermined position, the upper portion (30) can be moved from the non-operating position to the operating position, lifting, as shown in FIGS. 3 and 4. During the movement of the upper portion (30) from the non-operating position to the operating position, the passage of the connection means (4,5) from the non-operating configuration to the operating configuration occurs. In particular, the longitudinal constraint (4) and the transverse constraint (5) pass from the unlocking configuration to the locking configuration. The engagement assembly (42) is inserted in the housing assembly (41), and each second abutment (52) is arranged in contact with a respective first abutment (51).

1. A plotter for digital printing, comprising:
a main structure (2), arranged to be rested on a support surface (E);
a printing head, associated with the main structure (2) and movable along a substantially horizontal transverse direction (X), for a predetermined stroke in alternating and opposite directions;
a transport device (3), arranged to lead a material to be printed forwards along a longitudinal direction (Y) which is substantially horizontal and perpendicular to the transverse direction (X), which comprises a load-bearing frame (32);
a connection means (4,5) arranged to allow the coupling and the release of said load-bearing frame (32) with respect to said main structure (2);
the transport device (3) is removably associated with the main structure (2) by means of said connection means (4,5);
the connection means (4,5) is arranged to assume an operating configuration, in which the load-bearing frame (32) of the transport device (3) is coupled to the main structure and the transport device (3) is connected to the main structure (2) in a substantially rigid manner with respect to direct movements along the longitudinal direction (Y) and with respect to direct movements along the transverse direction (X), and a non-operating configuration, in which the load-bearing frame (32) is released from the main structure (2) and the transport device (3) is movable with respect to the main structure (2).

2. The plotter according to claim 1, wherein the connection means (4,5) comprises a longitudinal constraint (4), arranged to assume a locking configuration, in which it prevents movements of the transport device (3) with respect to the main structure (2) along the longitudinal direction (Y), and an unlocking configuration, in which it does not prevent movements of the transport device (3) with respect to the main structure (2) along the longitudinal direction (Y).

3. The plotter according to claim 2, wherein:
the longitudinal constraint (4) comprises at least one housing assembly (41), integral with one of the main structure (2) or the transport device, and an engagement assembly (42), integral with the other of the main structure (2) or the transport device (3);
the engagement assembly (42) is insertable in the housing assembly (41) in the locking configuration of the longitudinal constraint (4).

4. The plotter according to claim 3, wherein the engagement assembly (42) is insertable in the housing assembly (41) by means of a movement comprising a vertical component.

5. The plotter according to claim 1, wherein the connection means (4,5) comprises a transverse constraint (5), arranged to assume a locking configuration, in which it prevents movements of the transport device (3) with respect to the main structure (2) along the transverse direction (Y), and an unlocking configuration, in which it does not prevent movements of the transport device (3) with respect to the main structure (2) along the transverse direction (Y).

6. The plotter according to claim 5, wherein:
the transverse constraint (5) comprises at least a first abutment (51), integral with one of the main structure (2) or the transport device (3), and at least a second abutment (52), integral with the other of the main structure (2) or the transport device (3);
in the locking configuration of the transverse constraint (5), the first abutment (51) and the second abutment (52) are in contact with each other and are substantially locked with respect to the direct movements along the transverse direction (X).

7. The plotter according to claim 6, wherein the first abutment (51) and the second abutment (52) are arranged in contact with each other, in the locking configuration of the transverse constraint (5), by means of a movement comprising a vertical component.

8. The plotter according to claim 6, comprising elastic means, interposed between the first abutment (51) and the second abutment (52).

9. The plotter according to claim 1, wherein at least one portion (30) of the transport device (3) is vertically movable with respect to the main structure (2).
